(19) United States
(12) Patent Application Publication
(10) Pub. No.: US 2005/0021819 A1
(43) Pub. Date: Jan. 27, 2005

(54) Method, network element, and terminal device for making data packets

(76) Inventor: Kalevi Kilkki, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/484,829

(22) PCT Filed: Aug. 17, 2001
(86) PCT No.: PCT/EP01/09516

(51) Int. Cl. G06F 15/16

(52) U.S. Cl. 709/232

(57) ABSTRACT

The present invention relates to a method and a network element 3 for marking data packets to be transmitted in a packet switched network 10 with a priority information I, said packets being treated in said network 10 according to said priority information I. The priority information I is determined depending on a nominal bit rate NBR allocated to a certain service connection and a momentary bit rate MBR of said connection that is calculated depending on an importance marking I_{U} contained in a received data packet indicating an importance level of said data packet. Thus, the nominal bit rate NBR allocated to an end-user can be shared between a plurality of applications with different characteristics in order to give certain applications a higher priority than other applications. The present invention relates to a corresponding terminal device 9 to be used with such a network element 3.

### FIELD OF THE INVENTION

The present invention relates to a method and a network element for marking data packets to be transmitted in a packet switched network with a priority information, wherein that packets are treated in that network according to the priority information. Furthermore, the invention relates to a terminal device for generating corresponding data packets to be attached with said priority information by means of such network element by using such a method.

### BACKGROUND OF THE INVENTION

In common communication networks, in particular in mobile communication networks two main techniques for a data transmission are used: circuit switched data transmission and packet switched data transmission.

In the circuit switched domain a network establishes a service connection for data transmission by allocating a (radio) channel to a terminal, e.g. a mobile station, when a network host or service provider intends to transmit data via the network. Then data is transmitted via the network after the connection has been established. The radio channel is occupied by the terminal during the entire duration of the connection, even though in many cases only a small amount of data has to be transmitted.

In the packet switched domain the network transmits a data packet only when required, i.e. when data transmission has to be carried out. Thus, several terminals can use the same channel at a time. If a terminal generates a data packet, the network routes that packet via a first unattached channel to a recipient. Thus, as data transmission frequently consists of data bursts, the channels can be used in an efficient manner. This type of packet switched data transmission is used in the Internet and e.g. GPRS (General Packet Radio Service) systems and UMTS (Universal Mobile Telecommunications System) systems.

Data packets are routed in packet switched networks via mostly unpredictable routes depending on the actual data traffic and depending on the configuration of the corresponding routers. Thus, packets may encounter different delays inside the network caused e.g. by variation in occupancy levels of queues inside the routers. Furthermore, as a result, the network capacity, in particular within certain routes, has to be divided between different flows (or connections, or customers).

The division of the capacity between the different glows is controlled by the so-called SIMA (Simple Integrated Media Access) system as being described in U.S. Pat. No. 6,047,326 and U.S. Pat. No. 6,081,505.

SIMA is a way to provide QoS (Quality of Service) using differentiated services, i.e. SIMA is a complete service and implementation solution. Differentiated services is an approach to provide QoS in the internet. The basic idea is to provide relative (soft) guarantees for delivery of IP (Internet Protocol) data packets. Complex functions are left at the edges of the network. This allows simple core network routers and ensures the scalability.

According to the SIMA concept each user or application shall define only two issues before a connection is established, namely a nominal bit rate (NBR) and the selection between real-time and non-real-time service classes. NBR forms the basic relationship between charging and QoS, and it defines how the network capacity is divided among different connections during overload situations. Due to the simplicity of SIMA the network operator does not guarantee the continuous availability of NBR. Furthermore, a user or application is allowed to send data with any bit rate independently of the NBR. The strength of SIMA is its wide area of applications. SIMA does not require to build complex systems with several service classes each appropriate to only certain applications.

The idea of SIMA is that at the network edge packets are assigned a priority for a network domain. The packets are treated in the network domain according to the priority. The priority is depending on the ratio of a measured momentary bit rate (MBR) and NBR: If the MBR exceeds the NBR the priority is dropped and if the MBR is clearly below the NBR the priority is raised. Thereby, the NBR corresponds roughly to the bandwidth allocation for a given client.

Though the SIMA model as being described in U.S. Pat. No. 6,047,326 and U.S. Pat. No. 6,081,505 has been proved to be efficient and quite flexible, it has some limitations.

### SUMMARY OF THE INVENTION

It is therefore an object of the present invention to improve such data packet marking systems.

This object is achieved by a method for marking data packets to be transmitted in a packet switched network with a priority information for treating said packets in said network according to said priority information, comprising the steps of:
determining an importance marking contained in a received data packet indicating an importance level of said data packet,
determining a nominal bit rate allocated to a certain service connection,
calculating a momentary bit rate of said connection depending on said importance marking, and
determining said priority information depending on said nominal bit rate and said momentary bit rate.

Furthermore, the above object is achieved by a network element for marking data packets to be transmitted in a packet switched network with a priority information for treating said packets in said network according to said priority information, comprising:
importance marking determining means for determining an importance marking in an data packet receivable from a terminal device, said importance marking indicating an importance level of said data packet,
nominal bit rate determining means for determining a nominal bit rate allocated to a certain service connection,
calculation means for calculating a momentary bit rate of said connection depending on said importance marking being in connection with said importance marking determining means, and
priority information determining means for determining said priority information depending on said nominal bit rate and said momentary bit rate, said priority information determining means being in connection with said nominal bit rate determining means and said calculation means.

Furthermore, the above object is achieved by a terminal device for generating data packets to be transmitted in a packet switched network, said packets being treated in said network according to a priority information being attached to said packets by means of such a network element by using such a method, said terminal device comprising:
means for generating data packets, and
means for generating an importance marking attached to or inserted in said data packets indicating an importance level of said data packets.

The main idea of the invention is to provide an extension to prior art systems for marking data packets by taking into account importance marking made by the customer, end-user and/or a terminal device particularly used by a customer or end-user. The invention thus provides a system that takes into account the relative importance level informed by a customer (end-user) and/or terminal device thereby particularly dividing the network resources between different customers (end-users) and/or terminal devices purely on the NBR of each of them.

The invention furthermore allows to divide the data traffic in the network domain from one to a plurality of traffic classes for each connection between two or more end-users/terminal devices.

As a result the invention enables more resources to be reserved for applications that an end-user/terminal device judges relevant.

The above mentioned network element can be integrated into an integrated circuit, e.g. a ASIC (application specific IC) chip. This chip is preferably used in a router, preferably a wireless router as for use in mobile communication systems or in any other non-wireless router. It is further preferred that such a CHIP is used in a IP RAN (Internet Protocol Remote Access Node).

Preferably, the importance marking is performed by means of the terminal device. Thus, the marking of the data packets can be controlled automatically, e.g. by a running application being operated e.g. in that terminal device.

It is further preferred that the importance marking is generated by an end-user input to said terminal device. Thus, the marking of the data packets with the importance marking can be controlled manually by an end-user, preferably assisted by a corresponding application interacting with the end-user. As a result the end-user is able to give certain data packets a higher priority.

In a further preferred embodiment the NBR allocated to an end-user and/or a terminal device is shared between a plurality of applications of said end-user and/or terminal device depending on the importance marking of the end-user and/or the terminal device. Thus, different applications may be operated with different bit rates and hence different bandwidths depending on the characteristics of the applications indicated by the corresponding importance markings.

According to a further preferred embodiment a data packet received from an individual terminal device is marked prior transmission through said network with an individual priority information depending on the respective application having generated said packet. In a corresponding preferred terminal device the importance marking generating means are generating an importance marking depending on an individual application being allocated to a current data packet. Thus, it is possible to treat in the network domain each application individually with an application individual priority information. Thus, the flexibility of the system is further increased.

It can be assumed that the application is the main reason for a customer to mark packets with specific importance. However, there also is the possibility that within the packet flow of an application certain packets are marked with higher importance than some other packet belonging to the same flow.

In an embodiment of the invention the MBR is increased for more important data packets and/or decreased for less important data packets within a given traffic class, said increasing and/or decreasing is performed depending on said importance marking.

The increasing and/or decreasing is performed after a MBR measurement so that a modified MBR is taken into account in subsequent computations. The overall effect of packet importance is smoothed by means of a common measurement for all traffic classes. It is further preferred, that an overall network capacity is divided between different end-users and/or terminal devices substantially depending on that NBR of each end-user and/or terminal device. Thus, the bandwidth of the network is shared between users based on their individual NBR that is preferably depending on the purchased network access, in particular on the type of network access fees paid by the user, e.g. a flat rate or time-depending fee and/or a transmission rate depending fee.

According to a further embodiment the network traffic is counted individually for each individual traffic class. This can be performed by a network element by means of separate counters for the traffic in each of the classes. The difference between the classes is preferably in the delay characteristics (e.g., one class is intented to provide good enough delay characteristics for voice connections, while another one is suited for data connections). The number of classes shall be relatively small, preferably from 2 to 4.

It is further preferred, that an overall network traffic is counted irrespective of the traffic in said individual traffic classes. Thus, a corresponding network element comprises a counter for counting the overall network traffic.

Further advantageous developments are defined in dependent claims.

### BRIEF DESCRIPTION OF THE DRAWINGS

In the following, the present invention will be described in greater detail based on preferred embodiments with reference to the accompanying drawing, in which:

FIG. 1 shows a schematic diagram of an extension according to a preferred embodiment of the present invention to a SIMA system indicating a network element, a terminal device and a packet switched network.

### DESCRIPTION OF THE PREFERRED EMBODIMENTS

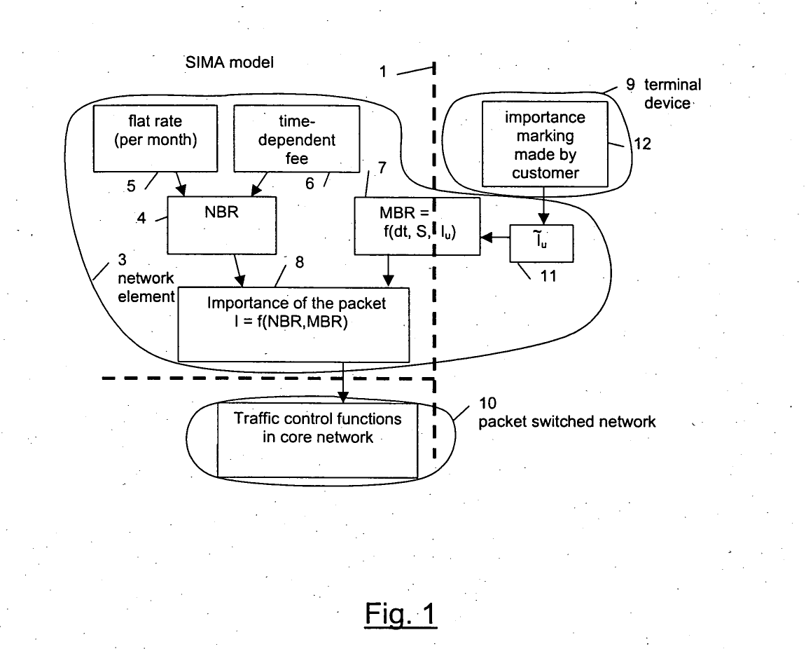

FIG. 1 shows a schematic diagram of a system for marking data packets according to a preferred embodiment of the present invention. FIG. 1 indicates both, prior art components of such a system as well as new components, both forming a preferred embodiment of the present invention. Prior art components are shown on the left side of a vertical dashed line 1 which is divided by a horizontal dashed line 2 into an upper left system part and a lower left system part. The upper left system part indicates the SIMA model according to U.S. Pat. No. 6,047,326 which is incorporated herein by reference. The lower left system part indicates the traffic control functions in the core network according to U.S. Pat. No. 6,081,505 which is incorporated herein by reference as well.

The packet marking system according to U.S. Pat. No. 6,047,326 comprises a network element 3 comprising a NBR determining unit 4 for determining a NBR. This NBR is for example determined based on a per month flat rate that is provided by flat rate register 5 providing information about a certain user, i.e. whether or not a user has purchased a network access based on a flat rate and, if so, the flat rate register 5 provides further information regarding e.g. the monthly price of the flat rate.

A further register, namely a time-dependent fee register 6 provides further information whether or not a certain user has purchased a network access based on a time-dependent fee.

Both information provided by the flat rate register 5 and the time-dependent fee register 6 are provided to the NBR determining unit 4 that determines a nominal bit rate based on the information provided by the registers 5 and 6.

Network 3 further comprises a MBR determining unit 7 for calculating a momentary bit rate MBR value of the data traffic, in particular the MBR of a certain connection. The MBR value is to be understood as an auxiliary parameter that does not indicate a real bit rate but an estimation thereof, however, if and only if the incoming packets are marked by an importance marking made by a customer, end-user and/or terminal device. The target of the calculation is to attain a system in which (A) the final marking of the packet follows as closely the changes in the packet marking made by the customer (end-user and/or terminal device) as possible, (B) the final packet marking is independent of the packet marking made by the customer if the all incoming packets are marked with the same importance.

The NBR is established by the network element or by a user. The value of the NBR represents an expected, however not guaranteed bit rate associated with a particular user or connection.

Network element 3 further comprises a calculation unit 8 that receives from NBR determining unit 4 and MBR determining unit 7 the NBR and the MBR, respectively, in order to compute a priority information/as a function of NBR and MBR.

Network element 3 operates as an access node for a terminal device 9. Terminal device 9 transmits data packets to network element 3 that are intended to be transmitted via a packet switched core network 10 to a recipient (not shown).

The data packets transmitted from the terminal device 9 to network element 3 are each assigned one of several priority levels according to the priority information computed in calculation unit 8, such as one of eight priority levels. Data packets received at the core network 10 are either accepted or discarded based on the priority information of the data packet and a status of one or more buffers at the core network 10.

According to a preferred embodiment of the present invention network element 3 further comprises a importance marking determination unit 11 for determining an importance marking Ĩ_{U}. The importance marking Ĩ_{U} is defined by the terminal device 9 or the end-user/customer assisted by the terminal device 9. Thus, if the terminal device 9 and/or the end-user/customer wants to share the NBR that is allocated to it/him, between two or more applications with different characteristics, the user may inform the network, in particular the network element 3, that data packets belonging to one of the applications are more important than data packets belonging to one, a number of, or all of the other applications.

Thus, a system is provided that is able to take into account relative importance levels informed by the customer and/or the terminal device 9 besides dividing the network resources between different customers and/or terminal devices 9 purely on the NBR of each customer/terminal device 9. The terminal device 9 comprises an importance marking unit 12 for incorporating the importance markings into data packets that are transmitted via an (e.g. air) interface to importance marking determination unit 11.

The importance marking determination unit 11 is connected with MBR determining unit 7 which in turn is connected with calculation unit 8. Similarly, NBR determining unit 4 is connected with calculation unit 8 that thus receives NBR values from NBR determining unit 4 and MBR values from MBR determining unit 7 for calculating a priority information being attached to a data packet transmitted to the core network that in turn transmits the resulting data packet to a recipient that is in a service connection with terminal device 9.

MBR determining unit 7 determines—besides receiving an importance marking from importance marking determination unit 11—further inputs regarding the data packets received from terminal device 9, e.g. a value regarding the size S of an actual data packet, preferably in bytes. A further input is an interarrival time dt that is derived as follows:

tᵢ is an effective measuring period for the traffic class i. For instance, if tᵢ=100 ms, the momentary bit rate is (approximately) measured taking into account the traffic within the last 100 ms. “Effective” refers here to the fact that the proposed system measures the momentary traffic using the exponentially moving average principle in which the measurement is effectively an exponentially weighted value of the past traffic.

Then there is parameter dt which is the interarrival time between the packet under consideration and the previous packet. If the parameter tₙ denotes the arrival instant of the packet under consideration and the parameter tₚ denotes the arrival instant of the previous packet, then the interarrival time dt is calculated as follows:
dt=tₙ−tₚ.

These values are particularly used for calculating an individual MBR value for an individual data packet received from terminal device 9.

The access part of the original SIMA can be described as the following algorithm for calculating priority information for marking data packets:
\tilde{I}=max {0, min [N−1, round (I′)]} (1)

$$\begin{matrix}{I}^{′} = {I}_{0} + \frac{ln ( I )}{ln ( z )} & ( 2 ) \\ I = \frac{NBR}{NBR} & ( 3 )\end{matrix}$$

In these equations the function round (x) defines the closest integer value near the value x. The function max (x, y) defines a value that is equal to x if x is greater than y. Otherwise the value of the function max (x, y) is y.

The function min (x, y) defines a value that is equal to x if x is less than y. Otherwise the function min (x, y) defines a value that is equal to y.

Furthermore, in the above equation (1) Ĩ defines the actual value of the priority information used for importance marking of the packet with limited granularity and scale.

In the above equations I′ is the priority information used for importance marking of a packet, whereby this priority information is based on a logarithmic scale with perfect granularity and unlimited scale.

Furthermore, in the above equations/is the priority information for the importance marking of a packet on linear scale.

NBR is the nominal bit rate for the flow and defines the share of resources for the flow, whereas MBR is the calculated/estimated momentary bit rate of the flow.

Furthermore z is the base number of the system as defined in U.S. Pat. No. 6,047,326 and is preferably set to 2.

Note: see also the notes in the other patent application NM5141 N related to this formula I₀ and N are explained there.

Furthermore, I₀ denotes an importance value constant that defines the base number of the importance scale, that is, the importance of a packet is I₀ if the momentary bit rate (MBR) is equal with the nominal bit rate (NBR). In the original SIMA system, the preferred I₀ is 4. Preferably, I₀ is adapted accordingly to the total number of priority or importance levels N, for instance I₀=round(0.625*N−1). Alternatively I₀ may preferably be set to 4.

A preferred total number of priority or importance levels is 8, but a smaller (or larger) number is possible as well. However, in order to guarantee an appropriate function of the system under various conditions, N should be at least 6 whenever possible.

The measuring algorithm for the MBR according to U.S. Pat. No. 6,047,326 is based on an exponential moving average principle. According to the present invention this algorithm is improved by taking into account the relative importance marking made by terminal device 9 or a customer. Furthermore, the determination of MBR is based on a separate counter for each traffic class and not just on one counter. However, an extra counter can be used to measure the total traffic over all traffic classes.

The following notation is used:
Tₙ denotes an arrival time of a data packet being currently under consideration.
Tₚ denotes an arrival time of a previous data packet using the same NBR.
S denotes a value indicating the size of a data packet, in particular in bytes.
Ĩ_{U} denotes an importance marking value generated by terminal device 9 or a customer.
Mᵢ denotes a value of a counter for a certain traffic class i.
tᵢ denotes a time constant for traffic class i that defines the effective measuring period.
N_{c} denotes the number of traffic classes, that is typically selected to 2 or 3.
Cₒ denotes a weight for the whole traffic measurement result. As the use of a counter for the whole traffic is optional, C₀ is equal to zero if the whole traffic measurement is not used.

The following calculations are carried out for each incoming packet that is received by network element 3 from terminal device 9.

For each i running from 1 to N_{c} Mᵢ is calculated according
Mᵢ=Mᵢ·e^{-dt/t}^{ᵢ} (4)

This calculation performs updating of the exponential moving average for each traffic class.

Assumed that the traffic class of a data packet is c then the corresponding value of the counter for that traffic class is calculated to

$${M}_{c} = {M}_{c} + \frac{( S / 8 ) \cdot {z}^{{I}_{u} - {I}_{o}}}{{t}_{c}} \qquad ( 5 )$$

Thereby increasing of the counter of the corresponding traffic class of the corresponding data packet is increased.

Next the value of the counter for the whole traffic using the same NBR is calculated for the common measurement by
M₀=M₀·e^{-dt/t}^{₀} (6)

$${M}_{0} = {M}_{0} + \frac{( S / 8 ) \cdot {z}^{{I}_{u} - {I}_{0}}}{{t}_{0}} \qquad ( 7 )$$

Finally, the result of the bit rate measurement is calculated as weighted sum according to the following equation:

$$MBR = [ {c}_{0} \cdot {M}_{0} + ( 1 - {c}_{0} ) \cdot {\sum }_{i = 1}^{{N}_{c}} {M}_{i} ] \cdot {z}^{{I}_{0} - {I}_{u}} \qquad ( 8 )$$

It is preferred to select z=2, because then a multiplication by zⁱ means in the digital domain that a shift of i digits has to be performed when i is an integer rather than a complex multiplication.

The common measurement M₀ is preferred since it gives some extra flexibility to the packet marking system even though it is not mandatory. In practice, if C₀ is large, the method favors those flows that have lower long term average traffic. Note that C₀ can also be zero, which means that only the individual traffic classes are measured, not the aggregate traffic.

The measurement result of the MBR is used next as described above and in U.S. Pat. No. 6,047,326.

The present invention is particularly advantageous as it needs modifications to the network elements 3 being in connection with terminal devices 9 only and does not need a modification of the core functions of the core network 10.

It is noted that actually, in the long run the packet marking system according to the present invention provides the same priority level for data packets even if a customer or a terminal device uses only one certain priority class, i.e. by sending all traffic with lower priority level a customer still obtains the same final service level. Thus, it is not possible to cheat the system.

It is noted that the present invention is not restricted to the preferred embodiments described above, but can be implemented in any fixed or wireless network environment using a packet switched data transmission only or a combination of packet switched data transmission and circuit switched data transmission. Furthermore, additional parameters can be used to calculate the MBR. Thus, the invention may vary within the scope of the attached claims.

1. A method for marking data packets to be transmitted in a packet switched network (10) with a priority information (I) for treating said packets in said network (10) according to said priority information (I), comprising the steps of:
determining an importance marking (I_{U}) contained in a received data packet indicating an importance level of said data packet,
determining a nominal bit rate (NBR) allocated to a certain service connection,
calculating a momentary bit rate (MBR) of said connection depending on said importance marking (I_{U}), and
determining said priority information (I) depending on said nominal bit rate (NBR) and said momentary bit rate (MBR).

2. A method according to claim 1, wherein said importance marking (Ĩ_{U}) is generated by means of a terminal device (9).

3. A method according to claim 1, wherein said importance marking (Ĩ_{U}) is generated by an end-user input (12) input to said terminal device (9).

4. A method according to claim 1, wherein said nominal bit rate (NBR) allocated to an end-user and/or a terminal device (9) is shared between a plurality of applications of said end-user and/or terminal device (9) depending on said importance marking (Ĩ_{U}) of said end-user and/or terminal device (9).

5. A method according to claim 4, wherein a data packet received from an individual terminal device (9) is marked prior transmission through said network (10) with an individual priority information depending on the respective application having generated said packet.

6. A method according to claim 1, wherein said momentary bit rate (MBR) is calculated further depending on:
a packet size (S) of a received data packet and
an interarrival time (dt) between a packet under consideration and a previous packet.

7. A method according to claim 1, wherein said momentary bit rate (MBR) is increased for more important data packets and/or decreased for less important data packets within in given traffic class, said increasing and/or decreasing is performed depending on said importance marking (I_{U}).

8. A method according to claim 1, wherein an overall network capacity is divided between different end-users and/or terminal devices (9) substantially depending on said nominal bit rate (NBR) of each end-user and/or terminal device (9).

9. A method according to claim 1, wherein network traffic is counted individually for each individual traffic class.

10. A method according to claim 1, wherein an overall network traffic is counted irrespective of the traffic in said individual traffic classes.

11. A network element for marking data packets to be transmitted in a packet switched network (10) with a priority information (I) for treating said packets in said network (10) according to said priority information (I), comprising:
importance marking determining means (11) for determining an importance marking (I_{U}) in an data packet receivable from a terminal device (9), said importance marking (I_{U}) indicating an importance level of said data packet,
nominal bit rate determining means (4) for determining a nominal bit rate (NBR) allocated to a certain service connection,
calculation means (7) for calculating a momentary bit rate (MBR) of said connection depending on said importance marking (I_{U}) being in connection with said importance marking determining means (11), and
priority information determining means (8) for determining said priority information (I) depending on said nominal bit rate (NBR) and said momentary bit rate (MBR), said priority information determining means (8) being in connection with said nominal bit rate determining means (4) and said calculation means (7).

12. A network element according to claim 11, wherein said calculation means (7) being capable of calculating said momentary bit rate (MBR) further depending on
a packet size (S) of a received data packet and
an interarrival time (dt) between a packet under consideration and previous packet.

13. (Cancelled)

14. A terminal device for generating data packets to be transmitted in a packet switched network (10), said packets being treated in said network (10) according to a priority information (I) being attached to said packets by means of a network element (3) according to claim 11,
said terminal device (9) comprising:
means for generating data packets, and
means (12) for generating an importance marking (Ĩ_{U}) attached to or inserted in said data packets indicating an importance level of said data packets.

15. A terminal device according to claim 14, wherein said importance marking (Ĩ_{U}) generation means (12) are generating an importance marking (Ĩ_{U}) depending on an application being allocated to a current data packet.
